(19) United States
(12) Patent Application Publication
(10) Pub. No.: US 2013/0029090 A1
(43) Pub. Date: Jan. 31, 2013

(54) BIAXIAL STRETCHABLE ELASTIC LAMINATE

(71) Applicant: Yuen-Lun Tsai, Taipei City (TW)

(72) Inventor: Yuen-Lun Tsai, Taipei City (TW)

(73) Assignees: Kenneth Cheng, Taipei City (TW); Eric Shyuu, Taipei City (TW)

(21) Appl. No.: 13/190,071

(22) Filed: Jul. 25, 2011

(51) Int. Cl. B32B 3/10; D04H 13/00

(52) U.S. Cl. 428/131; 442/328

(57) ABSTRACT

A biaxial stretchable elastic laminate is provided, which includes a biaxial elastic film, and a first uniaxial elastic fiber web layer and a second uniaxial elastic fiber web layer, wherein the first uniaxial elastic fiber web layer and the second uniaxial elastic fiber web layer are respectively laminated on the two opposite surfaces of the biaxial elastic film, and the stretchable direction of the first uniaxial elastic fiber web layer and the stretchable direction of the second uniaxial elastic fiber web layer are orthogonal to each other, and the elastic coefficients of the first uniaxial elastic fiber web layer and the second uniaxial elastic fiber web layer are lower than the elastic coefficient of the biaxial elastic film.

### BACKGROUND OF THE INVENTION

1. Field of the Invention

The present invention relates to an elastic laminate which is biaxial stretchable.

2. The Prior Arts

There is a well-known need to improve the fit and comfort of disposable diapers, training pants, other disposable sanitary products and the like in the consumer disposable market. Laminates that have high elasticity coupled with high elastic recovery and breathability are being sought as the means to satisfy this need. It is also desirable that the elastic laminate is biaxial stretchable. Disposable personal care and health care items are often breathable, and strong enough to endure handling in normal use. Breathability means gas or water vapor permeability, and the strength is related to the tensile properties. It is possible to enhance the stretchability of each polymer film in the laminate, but the manufacturing cost is increased because each polymer film must be made of good stretchable material. Accordingly, it is necessary to develop an elastic laminate having excellent strength and stretchability for use in making personal care items, health care items and the like.

Conventionally, the process for manufacturing a uniaxial stretchable nonwoven fabric is carried out by applying a predetermined uniaxial pulling force to the fabric, breaking the fiber structure of the fabric, and releasing the pulling force on the fabric to allow the fabric to retract back to its static position in order to form the uniaxial stretchable nonwoven fabric.

Conventionally, the biaxial stretchable elastic nonwoven fabric is formed by laminating a biaxial elastic film on one surface of the uniaxial stretchable nonwoven fabric. However, when the biaxial elastic film is used as one surface of the laminate after laminated, it will make user to have poor sense of touch, and thereby the clothes or the personal products will also make user to have poor sense of touch when they are made from such a laminate.

### SUMMARY OF THE PRESENT INVENTION

Accordingly, the objective of the present invention is to solve the problems of the prior art mentioned above.

In the biaxial stretchable elastic laminate of the present invention, a biaxial elastic film is sandwiched between a first uniaxial elastic fiber web layer and a second uniaxial elastic fiber web layer, wherein the stretchable direction of the first uniaxial elastic fiber web layer and the stretchable direction of the second uniaxial elastic fiber web layer are orthogonal to each other. Such obtained elastic laminate has excellent biaxial stretchability.

To achieve the above objective, the present invention provides a biaxial stretchable elastic laminate which comprises a biaxial elastic film, and a first uniaxial elastic fiber web layer and a second uniaxial elastic fiber web layer, wherein the first uniaxial elastic fiber web layer and the second uniaxial elastic fiber web layer are respectively laminated on the two opposite surfaces of the biaxial elastic film, and the stretchable direction of the first uniaxial elastic fiber web layer and the stretchable direction of the second uniaxial elastic fiber web layer are orthogonal to each other, and the elastic coefficients of the first uniaxial elastic fiber web layer and the second uniaxial elastic fiber web layer are lower than the elastic coefficient of the biaxial elastic film.

The biaxial elastic film of the present invention is made of an elastic polymer, and the biaxial elastic film can have or not have a plurality of air-permeable holes. When the clothes are made of the biaxial stretchable elastic laminate having a plurality of air-permeable holes, they will become more comfortable to be worn.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic cross-section view of a biaxial stretchable elastic laminate according to the present invention;

FIG. 2 is a schematic view showing that the first uniaxial elastic fiber web layer of the biaxial stretchable elastic laminate is capable of being elastically stretched only along the x-direction according to the present invention;

FIG. 3 is a schematic view showing that the second uniaxial elastic fiber web layer of the biaxial stretchable elastic laminate is capable of being elastically stretched only along the y-direction according to the present invention;

FIG. 4 is a schematic view showing that the biaxial elastic film of the biaxial stretchable elastic laminate is capable of being elastically stretched along the x-direction and the y-direction according to the present invention; and

FIG. 5 is a schematic top view showing that the biaxial stretchable elastic laminate is capable of being elastically stretched along the x-direction and the y-direction according to the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

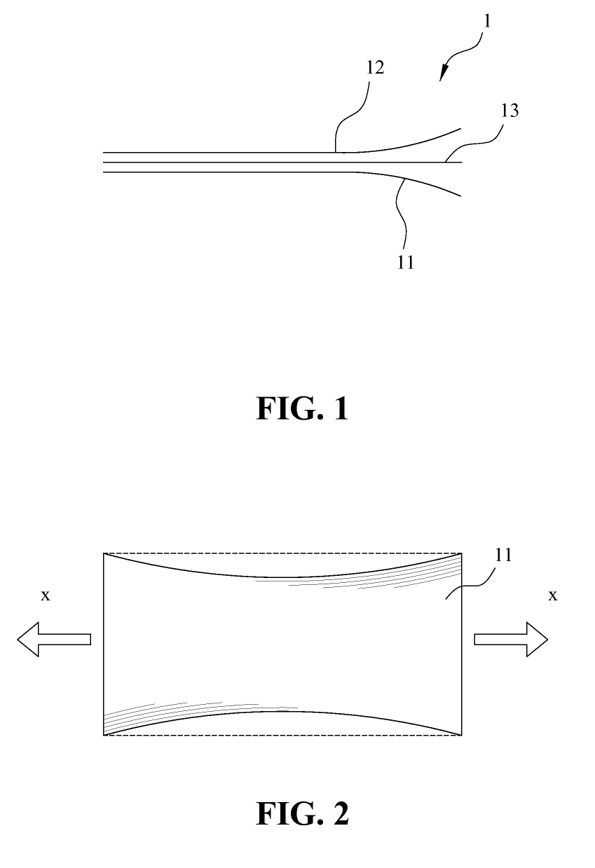

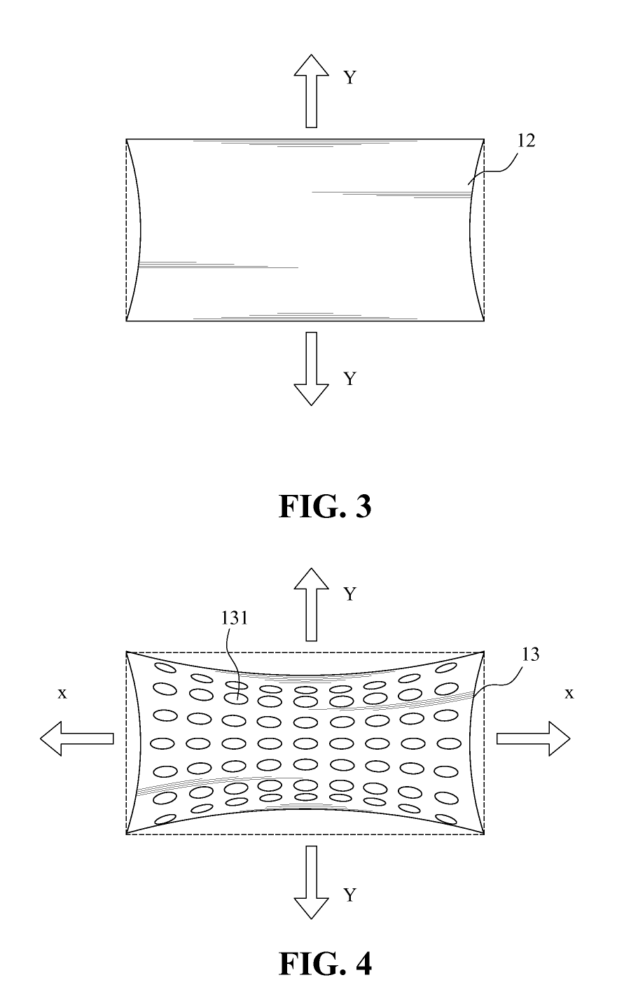

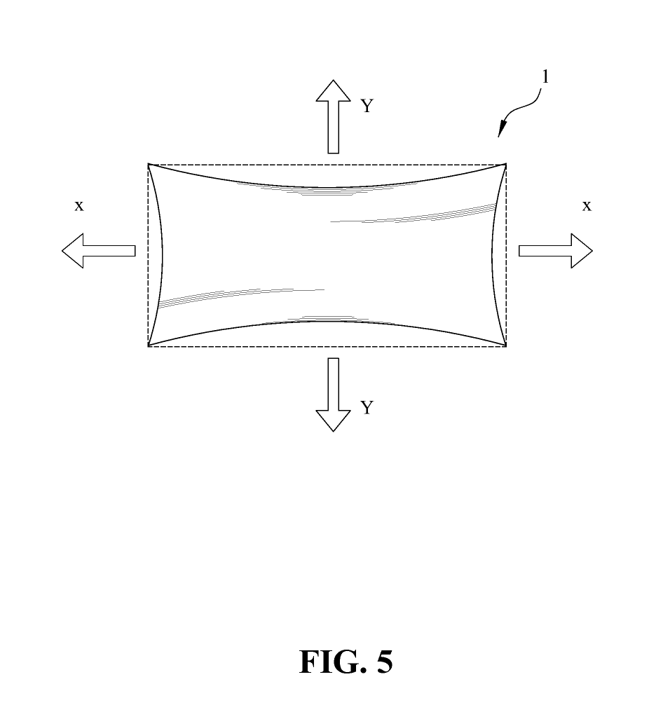

As shown in FIG. 1, the biaxial stretchable elastic laminate 1 of the present invention comprises a first uniaxial elastic fiber web layer 11, a second uniaxial elastic fiber web layer 12, and a biaxial elastic film 13. The elastic nonwoven fabric disclosed in U.S. Pat. No. 6,746,978 can be used as the first uniaxial elastic fiber web layer 11, and used as the second uniaxial elastic fiber web layer 12. The first uniaxial elastic fiber web layer 11 is capable of being elastically stretched only along the x-direction (as shown in FIG. 2). The second uniaxial elastic fiber web layer 12 is capable of being elastically stretched only along the y-direction (as shown in FIG. 3). The biaxial elastic film 13 is capable of being elastically stretched along the x-direction and the y-direction (shown in FIG. 4). According to the present invention, the first uniaxial elastic fiber web layer 11 and the second uniaxial elastic fiber web layer 12 are respectively laminated on the two opposite surfaces of the biaxial elastic film 13 for forming an elastic laminate 1 (as shown in FIGS. 1 and 5). The stretchable direction of the first uniaxial elastic fiber web layer 11 and the stretchable direction of the second uniaxial elastic fiber web layer 12 are orthogonal to each other. The elastic coefficients of the first uniaxial elastic fiber web layer 11 and the second uniaxial elastic fiber web layer 12 are lower than the elastic coefficient of the biaxial elastic film 13. Moreover, a plurality of air-permeable holes 131 can be firstly formed on the biaxial elastic film 13 before the first uniaxial elastic fiber web layer 11 and the second uniaxial elastic fiber web layer 12 are laminated onto the biaxial elastic film 13, such that the obtained laminate 1 can have air permeability.

The biaxial elastic film 13 is made of, for example, an elastic polymer. The weight percentage of the elastic polymer contained in the biaxial stretchable elastic laminate 1 is preferably greater than 15% by weight. The adhesive can be applied to the mating surfaces of the first uniaxial elastic fiber web layer 11, the second uniaxial elastic fiber web layer 12, and the biaxial elastic film 13 so that the first uniaxial elastic fiber web layer 11, the biaxial elastic film 13, and the second uniaxial elastic fiber web layer 12 can be sequentially bonded together to form the biaxial stretchable elastic laminate 1. Alternatively, the two mating surfaces are firstly brought together, and then the ultrasonic bonding, hot press bonding, discharge bonding, electronic beam bonding, static electricity bonding, or catalyst chemical bonding is applied to the two mating surfaces so that the two mating surfaces are bonded together. Alternatively, an elastic polymer can be applied to the surfaces of the first uniaxial elastic fiber web layer 11 and the second uniaxial elastic fiber web layer 12 by blown film extrusion, cast film extrusion, foam extrusion, or direct cast extrusion.

The first uniaxial elastic fiber web layer 11 and the second uniaxial elastic fiber web layer 12 are made of short chemical fibers or/and long chemical fibers. The first uniaxial elastic fiber web layer 11 and the second uniaxial elastic fiber web layer 12 both have high elasticity with good elastic recovery. The first uniaxial elastic fiber web layer 11 and the second uniaxial elastic fiber web layer 12 are made of, for example, nonwoven fabric. The fibers of nonwoven fabric can be mono-polymer, bi-component fibers, or blended fibers.

The biaxial elastic film 13 can be made of different kinds of elastic polymers. But the material original used must be fluid (such as air or liquid) impermeable. In this embodiment, an elastic polyurethane film having a thickness of 0.02 to 0.03 mm is used. In another embodiment, the biaxial elastic film 13 can be composed of multilayer films. The uniaxial elastic film can also be made of, for example, a monolayer elastomer or a foaming plastic, but these films must be made of fluid (such as air or liquid) impermeable material.

The biaxial elastic film 13 can be a film comprised of other highly elastic compounds, such as block copolymers which comprise two or more homo-polymer subunits linked by covalent bonds, and can be classified as AB (di-block), ABA (tri-block), BAB (tri-block), etc. Usually, such compounds exhibits relatively good elastic recovery, or low set from stretching over 100 percent when such highly elastic compounds are extruded alone as a single layer. In certain preferred embodiments, the elastic materials can comprise high performance elastic material such as styrene/isoprene/styrene, styrene/isoprene/butadiene or styrene/ethylene-butylenes/styrene (SIS, SBS, or SEBS) or Kraton™ elastomeric resins from the Kraton Chemical Co., which are the elastic block copolymers. The particular morphology of the block copolymers may have significant effect on the bulk properties.

Other useful elastic compositions for use as a biaxial elastic film 13 can include ethylene copolymers, such as ethylene vinyl acetates, ethylene/propylene copolymer elastomers or ethylene/propylene/diene terpolymer elastomers. Blends of these polymers alone or with other modified elastic or non-elastic materials are also used for fabricating the elastic film of the present invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A biaxial stretchable elastic laminate, comprising:
a biaxial elastic film; and
a first uniaxial elastic fiber web layer and a second uniaxial elastic fiber web layer,
wherein the first uniaxial elastic fiber web layer and the second uniaxial elastic fiber web layer are respectively laminated on two opposite surfaces of the biaxial elastic film, and a stretchable direction of the first uniaxial elastic fiber web layer and a stretchable direction of the second uniaxial elastic fiber web layer are orthogonal to each other, and elastic coefficients of the first uniaxial elastic fiber web layer and the second uniaxial elastic fiber web layer are lower than an elastic coefficient of the biaxial elastic film.

2. The biaxial stretchable elastic laminate according to claim 1, wherein the biaxial elastic film has a plurality of air-permeable holes.

3. The biaxial stretchable elastic laminate according to claim 1, wherein the first uniaxial elastic fiber web layer and the second uniaxial elastic fiber web layer are made of an elastic nonwoven fabric.

4. The biaxial stretchable elastic laminate according to claim 1, wherein the biaxial elastic film is made of an elastic polymer and a weight percentage of the elastic polymer contained in the biaxial stretchable elastic laminate is greater than 15% by weight.
